(19) United States
(12) Patent Application Publication
(10) Pub. No.: US 2008/0222040 A1
(43) Pub. Date: Sep. 11, 2008

(54) Disaggregation/reassembly method system for information rights management of secure documents

(76) Inventors: Mark J. Halsted, Wyoming, OH (US); Michael Bodner, Ann Arbor, MI (US); David Halsted, Ann Arbor, MI (US)

Correspondence Address: TAFT, STETTINIUS & HOLLISTER LLP, SUITE 1800, 425 WALNUT STREET, CINCINNATI, OH, 45202-3957, US

(21) Appl. No.: 12/070,358

(22) Filed: Feb. 15, 2008

Related U.S. Application Data
(60) Provisional application No. 60/901,459, filed on Feb. 15, 2007.

(51) Int. Cl. H04K 1/00

(52) U.S. Cl. 705/51

(57) ABSTRACT

The present invention pertains to a computerized system and method that provides for the secure storage and retrieval of electronic digital healthcare information; and, more particularly, to such a computerized system and method that provides for multiple access levels of such secure information; provides for secure access to portions of secure information dependent upon access privileges of the authorized user; provides virtually limitless data expansion capabilities; and provides for rapid access to such secure information by authorized users.

### CROSS-REFERENCE TO RELATED APPLICATIONS

This application claims the benefit of U.S. Provisional Application Ser. No. 60/901,459, entitled “DISAGGREGATION/REASSEMBLY METHOD SYSTEM FOR INFORMATION RIGHTS MANAGEMENT OF SECURE DOCUMENTS,” filed on Feb. 15, 2007, the disclosure of which is incorporated herein by reference. This application is related to and has at least one inventor in common with co-pending U.S. application Ser. No. ______ (Attorney Docket No. QIT01-GN001), entitled “DISAGGREGATION/REASSEMBLY METHOD SYSTEM FOR INFORMATION RIGHTS MANAGEMENT OF SECURE DOCUMENTS,” filed on Feb. 15, 2008, the disclosure of which is incorporated herein by reference.

### FIELD OF THE INVENTION

The present invention pertains to a computerized system and method that provides for the secure storage and retrieval of electronic digital healthcare information; and, more particularly, to such a computerized system and method that provides for multiple access levels of such secure information; provides for secure access to portions of secure information dependent upon access privileges of the authorized user; provides virtually limitless data expansion capabilities; and provides for rapid access to such secure information by authorized users.

### BACKGROUND OF THE INVENTION

Currently it is becoming clear that some major shifts in basic electronic data storage and retrieval architecture are in the offing on a number of fronts. Several long-term trends are converging rapidly. The trends are well known:
Electronic/Digital Data stores, already large, are expanding at an increasing rate
Demands on data stores are growing as more users want more kinds of access to disparate data, and want it quickly
Public and governmental concerns about privacy issues, combined with new compliance structures, (e.g., SOX or HIPAA) lead to a tightening and legal regulatory environment
Conventional data warehouses, and traditional content-, security, and data-management schemes, (not to mention traditional IS departments) cannot cope with this convergence of forces and are being overwhelmed.

Traditional topologies involve placing entire documents in segregated folders and giving classes of users rights to view these documents as wholes; security granularity stops at the document or report level. Problems with such an approach are well known. Complex tree structures and inheritance of privilege can lead to frustration with the complexities of security management and can cause serious performance issues. Simplistic storage schemes lead to security breaches involving large numbers of sensitive records, with sometimes devastating serious consequences. The complexity of such systems is increased when some users groups are cleared to see only portions of documents, leading to the need to build many redacted copies to guarantee secure access to each class of user. These technical challenges are driven by long-term technological and social trends—ever-expanding data stores, simultaneous and conflicting demands for more access and more security, new trends and data storage technologies—and their cost to businesses and non-profits will all increase over the next several years.

### SUMMARY OF THE INVENTION

Aspects of the present invention address this need by providing an improved system for securely storing and retrieving electronic digital healthcare information.

It is a first aspect of the present invention to provide a computer-implemented method of distributing secure healthcare patient information that includes the steps of: providing a plurality of information servers, requesting, by a user, healthcare patient information, authenticating the user to determine an authorization level of the user, transmitting one or more build information fragments and one or more patient information fragments to a document assembler based, at least in part, on the authorization level of the user, assembling, by the document assembler, the one or more patient information fragments based upon the instructions from the one or more build information fragments to produce assembled healthcare patient information, and outputting the assembled healthcare patient information to an output device. The information servers store one or more of a plurality of encrypted data fragments, the plurality of encrypted fragments comprising patient information fragments and one or more build information fragments that provide instructions for decrypting the patient information fragments and combining the decrypted patient information fragments into assembled healthcare patient information.

In one embodiment of the first aspect, the information servers also store a plurality of healthcare form templates, and the assembled healthcare patient information includes, at least in part, a combination of one or more patient information fragments and one or more healthcare form template. In another embodiment, the output device may include a display device, a computing device, a portable electronic device, a printing device, and/or a software application.

In another embodiment of the first aspect, the method further includes the step of: prior to the transmitting step, replicating the encrypted data fragments and storing the replicated encrypted data fragments in the plurality of information servers. Another embodiment of the first aspect further includes the step of: prior to the assembling step, comparing at least one data fragment to at least one replicated encrypted data fragment to confirm the integrity of the at least one encrypted data fragment.

In yet another embodiment of the first aspect, the transmitting step further includes the step of recording, in a database, details of the transmission of the build information fragments and the patient information fragments to the document assembler. In another embodiment, the requesting, authenticating, transmitting and assembling steps are implemented as web services on the Internet, and the web services may be implemented in Hypertext Markup Language (HTML), Extensible Markup Language (XML), PHP, JavaScript and/or Asynchronous JavaScript and XML (AJAX).

In still yet another embodiment of the first aspect, the plurality of information servers may include an electronic storage device, an internal hard drive, an external hard drive, an external flash drive, a network server device, an Internet server device, a web server, and/or a file server. In another embodiment, the assembled healthcare patient information is not capable of being stored in an electronic format by the output device.

It is a second aspect of the present invention to provide a computer-implemented system for distributing secure healthcare patient information that includes a computing device adapted to output healthcare patient information upon request by a user, an identity server adapted to confirm the user's identity and to determine an authorization level of the user, a plurality of information servers, a file server adapted to collect the plurality of encrypted data fragments from the plurality of information servers, and decrypt the encrypted data fragments based, at least in part, on the instructions for decrypting the patient information fragments, and a document server. Upon request from the user, the document server transmits the assembled healthcare patient information to the computing device for output. The information servers may store a plurality of encrypted data fragments, the plurality of encrypted fragments comprising patient information fragments and one or more build information fragments that provide instructions for decrypting the patient information fragments and combining the decrypted patient information fragments into assembled healthcare patient information. The document server is adapted to receive user requests for healthcare patient information, communicate with the identity server to determine the user's authorization level, communicate with the file server to retrieve the collected encrypted data fragments, and assemble healthcare patient information based, at least in part, on the instructions from the build information fragments to produce assembled healthcare patient information.

In one embodiment of the second aspect, the information servers also store a plurality of healthcare form templates, and the assembled healthcare patient information includes, at least in part, a combination of patient information fragments and a healthcare form template. In another embodiment, the computing device may be a display device, a portable electronic device, a printing device, and/or a software application.

In another embodiment of the second aspect, the system further includes redundancy servers adapted to replicate the encrypted data fragments and storing the replicated encrypted data fragments in the plurality of information servers, wherein at least one encrypted data fragment is compared to at least one replicated encrypted data fragment to confirm the integrity of the at least one encrypted data fragment.

In another embodiment of the second aspect, the system also includes an event database that records at least all user requests, user access attempts, healthcare patient information assembled and assembled healthcare patient information outputted.

In yet another embodiment of the second aspect, the plurality of information servers may include an electronic storage device, an internal hard drive, an external hard drive, an external flash drive, a network server device, an Internet server device, a web server, and/or a file server.

In still yet another embodiment of the second aspect, the encrypted data fragments may include a patient name, a patient identification number, a patient date of birth, a patient telephone number, a patient address, patient conditions, patient symptoms, a physician name, a physician referral, physician notes, diagnosis, suggested treatments, prescribed treatments, treatments previously attempted, outcomes of previously attempted treatments, suggested medications, medications previously prescribed and/or outcomes of previously prescribed medications.

It is a third aspect of the present invention to provide a system for distributing secure healthcare patient information that includes a computer-implemented authentication component adapted to authenticate a user's request for healthcare patient information, a computer-implemented data fragment component adapted to store a plurality of encrypted patient information fragments and transmit the encrypted patient information fragments in response to an authenticated user request, a computer-implemented locks component adapted to allow or disallow access to the encrypted patient information fragments based, at least in part, on output from the authentication component, a computer-implemented build information component adapted to store build information fragments that provide instructions for decrypting the encrypted patient information fragments and combining the decrypted patient information fragments into a healthcare patient information document, a computer-implemented composition component adapted to compose the healthcare patient information document based, at least in part, on the instructions from the build information component, and an output component for receiving and outputting the healthcare patient information document.

It is a fourth aspect of the present invention to provide a computer-implemented method of distributing secure healthcare patient information, comprising the steps of: providing a plurality of information servers, replicating the encrypted data fragments and storing the replicated encrypted data fragments in the plurality of information servers, comparing at least one data fragment to at least one replicated encrypted data fragment to confirm the integrity of the at least one encrypted data fragment, requesting, by a user, healthcare patient information, authenticating the user to determine an authorization level of the user, transmitting build information fragments and patient information fragments to a document assembler based, at least in part, on the authorization level of the user, assembling, by the document assembler, the patient information fragments based upon the instructions from the build information fragments to produce assembled healthcare patient information, and outputting the assembled healthcare patient information to an output device. The information servers store a plurality of encrypted data fragments, the plurality of encrypted fragments including patient information fragments and build information fragments that provide instructions for decrypting the patient information fragments and combining the decrypted patient information fragments into assembled healthcare patient information. The information servers also store a plurality of healthcare form templates. The assembled healthcare patient information includes, at least in part, a combination of patient information fragments and healthcare form template.

From the foregoing disclosure and the following detailed description of various preferred embodiments it will be apparent to those skilled in the art that the present invention provides a significant advance in the art of secure storage and retrieval systems. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a schematic diagram of a data storage and retrieval system in accordance with one embodiment of the present invention;

FIG. 2 is a schematic diagram of an alternate embodiment of the data storage and retrieval system of the present invention;

FIG. 3 is a schematic diagram of an alternate embodiment of the data storage and retrieval system of the present invention; and

FIG. 4 is an exemplary computer screenshot depicting an implementation of the data storage and retrieval system in accordance with one embodiment of the present invention;

FIG. 5 is an exemplary computer screenshot depicting an implementation of the data storage and retrieval system in accordance with one embodiment of the present invention;

FIG. 6 is an exemplary computer screenshot depicting an implementation of the data storage and retrieval system in accordance with one embodiment of the present invention;

FIG. 7 is an exemplary computer screenshot depicting an implementation of the data storage and retrieval system in accordance with one embodiment of the present invention;

FIG. 8 is an exemplary computer screenshot depicting an implementation of the data storage and retrieval system in accordance with one embodiment of the present invention;

FIG. 9 is an exemplary computer screenshot depicting an implementation of the data storage and retrieval system in accordance with one embodiment of the present invention; and

FIG. 10 is a schematic diagram of an exemplary environment in which the data storage and retrieval system of the present invention may operate.

### DETAILED DESCRIPTION

It will be apparent to those skilled in the art that many uses and variations are possible for the system and method of the present invention. The following detailed discussion of various exemplary embodiments will illustrate the general principles of the invention. Other embodiments will be apparent to those skilled in the art given the benefit of this disclosure.

The present invention pertains to a computerized system and method that provides for the secure storage and retrieval of electronic digital information; and, more particularly, to such a computerized system and method that provides for multiple access levels of such secure information; provides for secure access to portions of secure information dependent upon access privileges of the authorized user; provides virtually limitless data expansion capabilities; and provides for rapid access to such secure information by authorized users.

The present invention provides a distributed, component-oriented system and method for storing, securing, and delivering electronic digital information (such as documents, files, resources, media and the like) to users based upon the users' unique rights and privileges that can meet the known challenges in the coming years. Document-based content (medical reports, medical interviews, patient records, etc.) as well as other digital information and media can be deconstructed into component parts (identified in this application as “Content Fragment Quanta,” “CFQs” or “fragments”) that mirror how and by whom they may be used. The content parts can be stored as encrypted fragments in different places. The isolated fragments by themselves have no meaning; even if the encryption is broken, the context of such fragments is lost. When a user enters the system with proper authentication through a highly secure identity management engine, he or she will be able to gather only portions of a content to which he or she has rights. The system will gather for the user the rule sets (in the form of meta data or keys in the embodiments described herein) he or she requires reassembling the fragments into a meaningful whole. Only that user, in that session, will ever see the reassembled fragments.

More specifically, the computerized system and method of the present invention deconstructs both the structured and unstructured content of information into encrypted fragments. Access to this data is filtered through a distributed right-enforcement system; meaningful documents (or other digital content) only “exist” at the moment when the properly-credentialed user is seeing/accessing reconstructed versions of them. At the same time, the system is designed to be highly scalable across inexpensive machines. Thus, by breaking the electronic information into smaller fragments, and by externalizing and distributing security information and metadata, the invention moves to a new paradigm that addresses the converging trends of increasing data stores, increasing access needs, increasing concerns about privacy, security, and compliance, and the need for a new level of granularity and security in storage paradigms.

As an important aspect to the invention, protected content is not stored in a meaningful form anywhere on the information network (such as the Internet, an intranet, a back-end server system, or some other information network). Information components are only exposed through secure Information rights Management rules, which expose the information, instructions and keys necessary to fetch, decrypt, and assemble the final delivered object. Thus, a patient report to a medical insurance company would contain only information that the author/owner designated is allowable to that viewer. The viewer does not get a result that is subsequently filtered. Redaction is accomplished, not by “blacking out” sections of the document, but by delivering in assembled form only the content that the system determines that user is permitted to see—and that content exists in re-composed form only on the user's browser during the time that the user is viewing it. When the browser closes, nothing is left but the isolated, encrypted fragments stored on the information network.

In the medical arena, one could quickly access critical and valuable diagnostic and procedural data to an authorized viewer, while guaranteeing patient privacy. Sensitive information, such as identifying information or social security numbers can be stored in encrypted fragments that are worthless in isolation. Sensitive data of all kinds can be both secure and readily available to authorized access under such a scheme.

The exemplary embodiments of the present invention depend on the distribution of meaningful information over a wide virtual area. Because of this, the exemplary embodiment is tailor-made for deployment on large numbers of geographically-distributed commodity servers running inexpensive software. Content will be asynchronously replicated and distributed into tagged, encrypted fragments across a number of computer servers. Identity management will authenticate the user, determine the user's access rights; while document assemblers will (based upon the user's access rights) set up the proper fetch-and-assemble mechanism from meta data (or other keys or instruction information) that is also stored and distributed among several servers, and deliver the result to a browser-based front end, using rapid delivery systems such as AJAX where asynchronous marshalling of content is possible. The information can be exposed as web services or in portlets (portal components) for maximum flexibility and reuse.

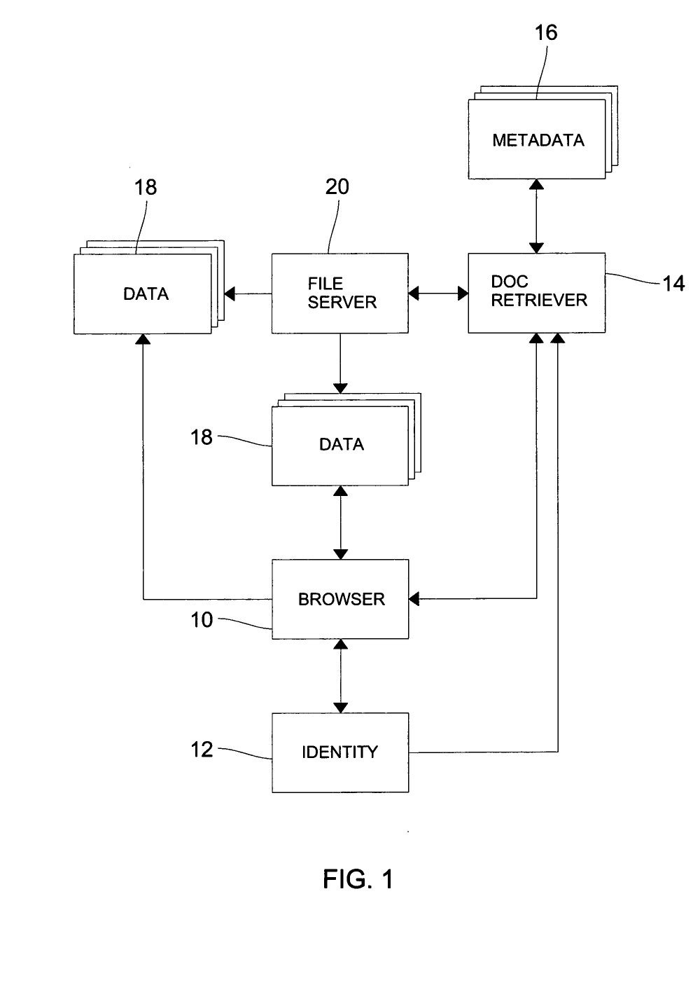

As shown in FIG. 1, an exemplary system includes a computer browser 10 or other computer interface in which the user will request and access information according to the invention. Initially, upon or prior to an information request, an identity server 12 will confirm that user's identity and access levels or privileges in any appropriate method known to those of ordinary skill in the art. Once the user's identity and access levels have been established by the identity server, the user initiates an information request that is transmitted to a document retriever server 14. Based upon the information request and the user's access rights, the document retriever server 14 will access the appropriate instructions, fragment locations and decryption keys (collectively, the “build data”) for building the requested information from one or more metadata servers 16. The metadata servers 16 include an object or a set of objects (fragments themselves in the exemplary embodiment) that contain directions as to how to reassemble the content information (Content Fragment Quanta) into entire objects. The metadata assembly directors also manage the identifications for each fragment in the set, including superseded (updated) portions and encrypted keys (part of the global encryption chain). The content information itself is broken into a plurality of Content Fragment Quanta (CFQs), which are stored at a plurality of separate data locations 18 (which could number in the thousands) across the information network.

At the direction of the document retrieval server 14, and based upon the build data from the metadata servers 16, a file server 20 will access the encrypted fragments that are distributed among the plurality of data locations 18. In the exemplary document assembly process, the system will call both the document retriever server 14 and the file server 20, which contain maps between the build data and the actual locations of the encrypted fragments themselves 18.

The build data retrieved from the various metadata sources 16 may include instructions on both how to construct the information request from the various plurality of CFQs contained in the data stores 18; but also the encryption keys for de-encrypting each of the individual fragments. In one embodiment of the present invention it is also possible that each CFQ will include an encryption key or a portion of an encryption key for a next CFQ so that each content fragment quanta that are accessed must be encrypted in order (a daisy chain decryption methodology) to further increase the difficulty in “hacking” meaningful content.

Once all of the decrypted fragments are collected by the file server 20 and delivered to the document retriever 14 based upon the build data from the metadata servers 16, the CFQs are combined according to the build data into information content, and the information content is then transmitted by the document retriever to the browser 10 for viewing or other actions by the user.

In an exemplary embodiment, the CFQs are duplicated (for redundancy) and distributed among the plurality of data locations 18 and the build data from the metadata server 16 includes a “clone list” to access such duplicated CFQs should one of the data locations 18 be compromised or should an access attempt to any CFQ should fail for any reason. Additionally, an exemplary embodiment provides a check-sum capability. One way to implement such a check-sum capability is to provide two redundant file servers 20, each of which access and decrypt a CFQ from the same or different data locations 18, where such two CFQs are compared to ensure that they are identical (either before or after decryption). Alternatively, a comparator engine may be utilized to assemble various CFQs from multiple data locations 18 to determine whether the same assembled product is delivered. In an exemplary embodiment, each CFQ and each fragment of build data contains information about its genesis, its location and its versioning through time. Each piece may also be aware of the location and versioning of any clones that may exist as redundant backups or checksum generators.

Exemplary embodiments of the system have the capability to record the actual access event for each user each time the user accesses a specific CFQ or build data object. Reporting would then be possible to perform audit and compliance functions, such as for HIPAA and SOX.

The browser 10, identity server 12, document retriever 14, metadata server 16 and file server can all be considered as “nodes” to the implementation of the system. While these nodes are described as separate elements, it will be appreciated by those of ordinary skill that any two or more of these nodes (and/or their respective functionality) can be combined into a single element. In a proof-of-concept embodiment of the present invention (described further below), the nodes have been implemented as simple PHP Web services. These Web services accept XML requests and communicate frequently with each other. The basic design principle is that no node trusts a single request coming in from any other node; any request to any node is re-checked against other services. The result is a system with many lightweight messages passing back and forth in the background.

In a more advanced embodiment, the background services are configured so that they only respond to certain kinds of requests from certain known IP addresses. In other words, even a well-formed request from an unregistered machine is ignored. In order for a node to yield information in this advanced embodiment, it must receive a valid request from another machine that is empowered to make that type of request. CFQs are stored on one server or set of servers while build data is stored on another server or set of servers. By splitting the CFQ from the build data (metadata) the invention makes the information quite safe—even if the encryption is broken for that CFQ, the CFQ's context is lost (without the associated metadata), and the CFQ does not carry enough information by itself to be useful. The build data links a CFQ to a role or an access level. Only a user in that access level can generate a key that will open the lock. CFQs are identified by universal identifiers in the form of URIs, but these do not point to the physical location of any CFQs.

The user of URIs as identifiers provides several advantages. The URIs may use domain names that are under the control of the particular organizations operating the system. Hierarchical relationships may be modeled with URIs; http:/foo.com/hr might represent the Human Resources department of an enterprise. Documents, fragments and roles can be designated with meaningful identifiers, if desired, and it is possible to build a hierarchy-aware rule-enforcement system if the identifiers are used correctly. If two organizations, for example, use the system and use domains they control, there should never be a naming conflict if they “merge” parts of their permissions systems. Finally, XML messaging can take advantage of XML namespace mechanisms to reduce the size of transmissions, since XML namespaces allow the easy translation of full URIs to short prefixes across documents.

When considered as a group of functional nodes, an embodiment of the computerized system of the present invention will include the following functional nodes:
1) Authentication node. This node receives two kinds of queries. In response to a user name/password combination, it returns a valid session ID or a 0 if authentication fails. If the session ID itself is passed back to the authentication node, the node responds with the user ID if the session is still valid. In general, with the exception of the authentication event itself, only the session ID is passed back and forth over the data link. In this implementation, the session id is fully stateless.
2) Roles node. This node links authenticated user IDs to system-defined roles. Roles are used to build keys and to define locks.
3) Fragments node. The fragments node releases fragments in response to requests from other services. Each fragment release requires a check against the authentication node. No fragment is released except to an identified user, and only the fragments with locks that can be unlocked by keys created for that user will be released. Fragments are identified with a virtual URI. Requests coming in to the fragments node contain fragment URIs and user identifiers. The fragments node translates the virtual fragment URI information to a physical request for those fragments the user can unlock. In this minimalist implementation, the fragments node also decrypts the permissible fragments upon request.
4) Locks node. Contains links between roles and fragments.
5) Form templates node. Contains frameworks that can be filled with fragments. Each filled form is a numbered instance of that form, so that, for example, a medical transfer form might have a numbered instance for each patient for which it is filled in. The positions that can be filled in within the form are designated with a URI-like universal identifier.
6) Form fragments node. Finds the fragments needed to fill in each instance of a form. This node calls the fragments node, so it never returns any data that cannot be unlocked by the current user.
7) Composer. Returns instances of a form with URI indicators that tell the system where to place decrypted fragments.

The actual substitution of data for placeholders takes place at a client. In essence, the client is also a node in the system. However, only the client actually places meaningful data in the proper positions within the form to create meaningful documents. Since the client is a participant in the system, the nature of the client might affect the implementation of the nodes.

This embodiment of the system was written to support a client node on a server that would create and return filled-in Microsoft Word documents to the browser. A client node might also be, for example and without limitation, a Word document with Visual Basic macros that call the services on the back end, a pure HTML/JavaScript Web page, a set of Web services intended to fill a data warehouse, or a thick-client implementation.

The CFQ can come in many different forms. For example, a CFQ can be a form template or even a part of a template. Form templates create an empty framework for other CFQs. An instance of a form is a form filled with data. Each meaningful position within a form is identified by a unique ID, and each CFQ is marked with build data (metadata) showing which form, instance and position it falls. When a form is requested from the system, the instance is detected, and IDs for all of the fragments for that instance to which the requesting user has permitted access are inserted into the form template. The form template is only “filled” with meaningful data by the client.

In the exemplary embodiment there are two general classes of such Content Fragment Quanta. The first class is Machine Algorithmic Generation. This is the class of CFQ that can be generated in an automated manner by applying templates or algorithmically derived rules to a set of source document objects, such as medical insurance forms or reports in standard formats. Another class of CFQ is Subject Matter Expert Generation, which is a class of CFQ that has been tagged, marked-up, value-added and/or redacted in such a way by subject matter expert(s) (human, automated, or a combination of both) so as to enable the assembly for any number of target user groups.

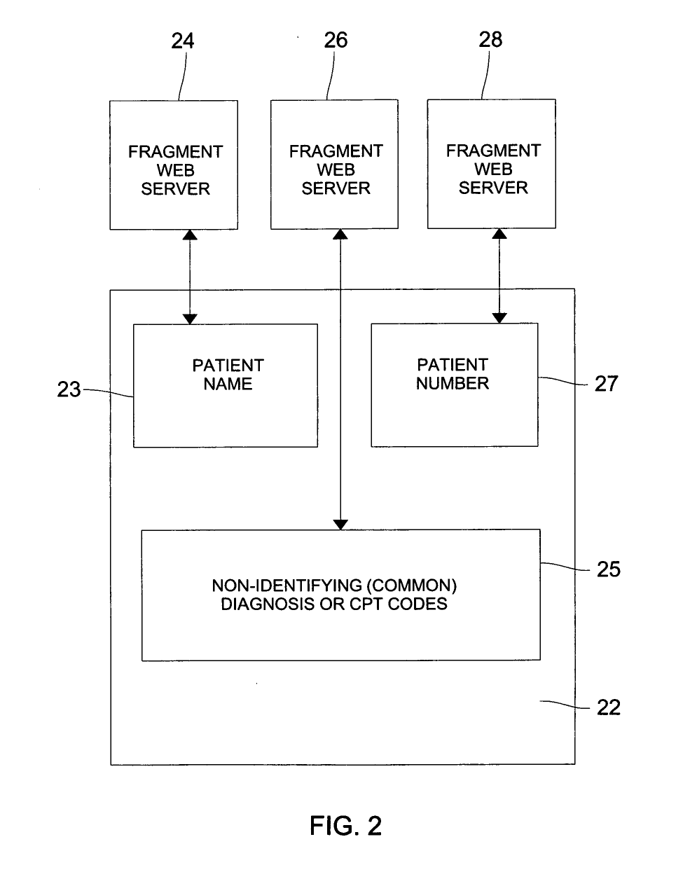

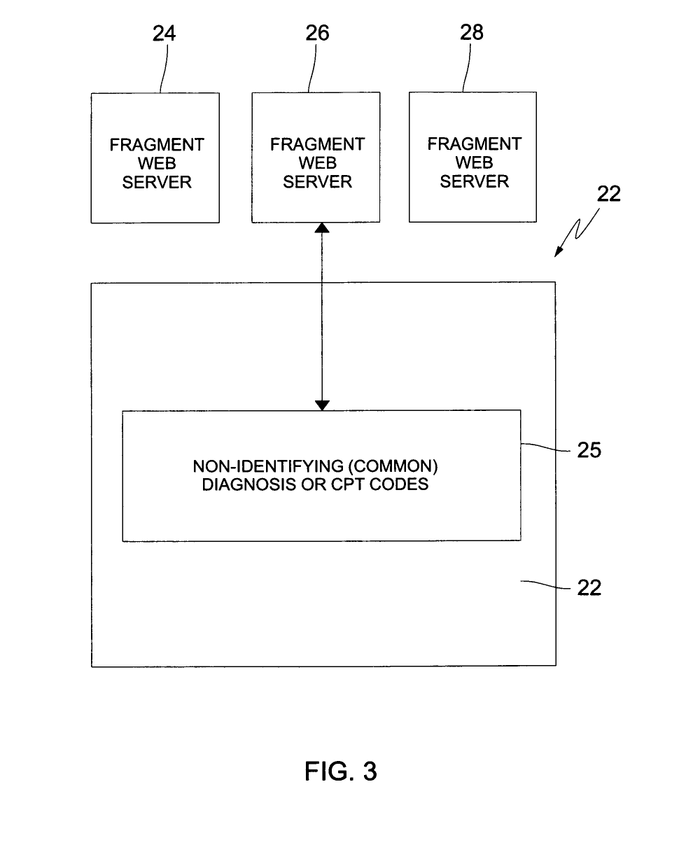

FIG. 2, for example, illustrates the disassembly of a medical form into four CFQs. In this illustration, a template CFQ 22 includes the structure and location for other content CFQs, which include a “patient name” CFQ 23 on server 24, a “diagnosis” CFQ 25 on server 26 and a “patient number” CFQ 27 on server 28. According to the present invention, if a user wishes to access this patient chart, if the user does not have an appropriate access level to see the patient name and patient number, the document 30 will be constructed by the system with only the template CFQ 22 and the diagnosis CFQ 25 from server 26 as shown in FIG. 3.

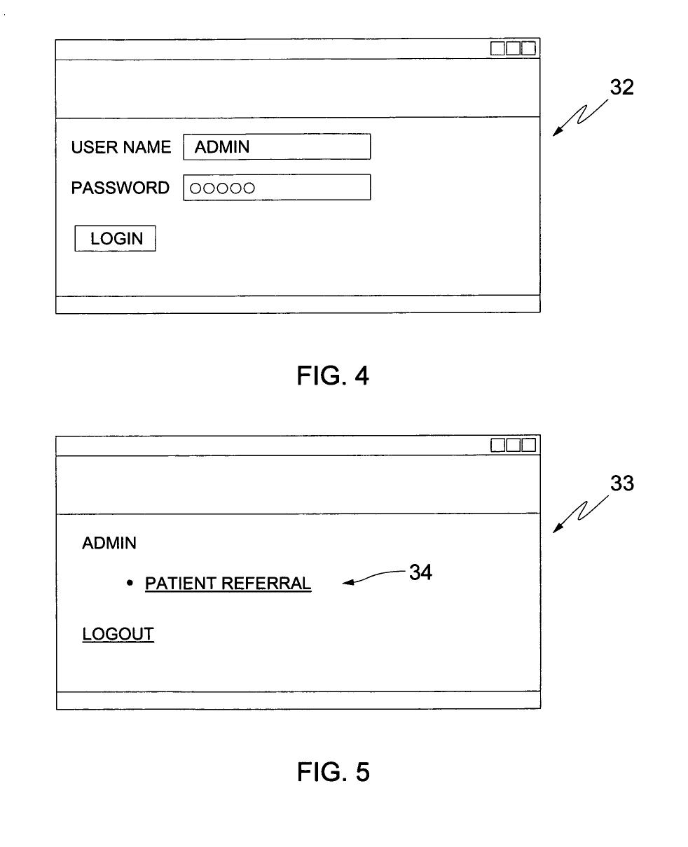

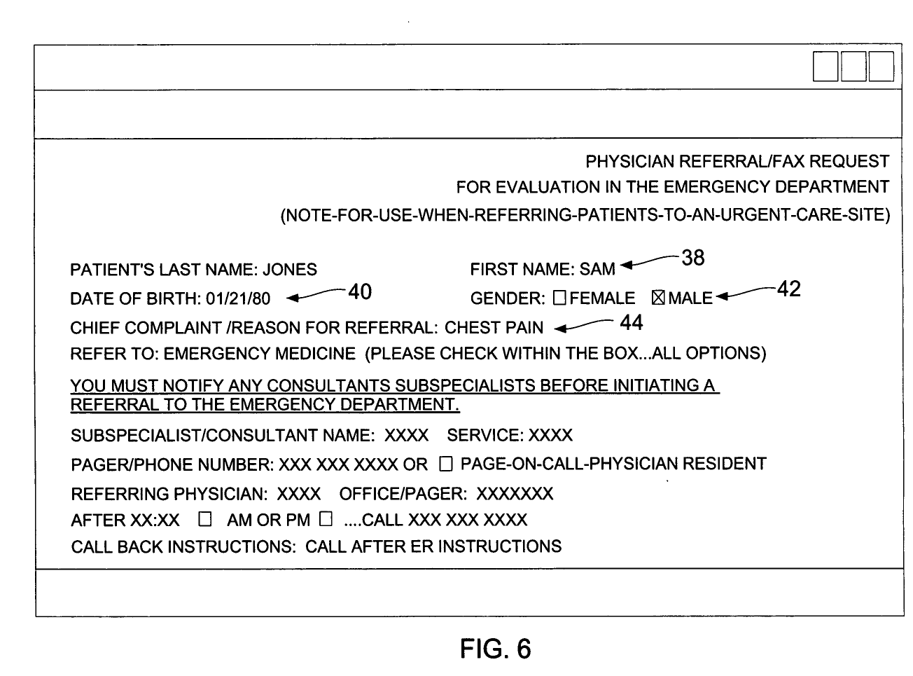

FIGS. 4-9 depict screen shots from an actual implementation of an embodiment of the present invention. As shown in FIG. 4, a login screen 32 is shown where an administrator (high level of access) logs into the system. As shown in FIG. 5, after logging in, the operator is taken to a screen 33 that presents the operator with choices of documents to access. In the present embodiment, only Patient Referral documents 34 are accessible. Once this hyperlink 34 is activated by the operator, an MS Word document is created by the embodiment of the invention on-the-fly for the operator as shown in FIG. 6. This document is not stored in this form anywhere on the system. Instead, a template version of the Word document without any information filled into the fields is stored in one location as a CFQ; while fragmented, encrypted versions of the field data are stored in other locations. The document and its data are brought together only at the moment of request, in a version tailored to the permission level of the operator. As can be seen in FIG. 6, the permission levels of the present operator are high, since the patient Last Name and First Name 38, Medical Record ID number (not shown) and telephone number (not shown) are filled into their corresponding fields on the form, along with the diagnosis 44, date of birth 40, gender 42 and other less sensitive information.

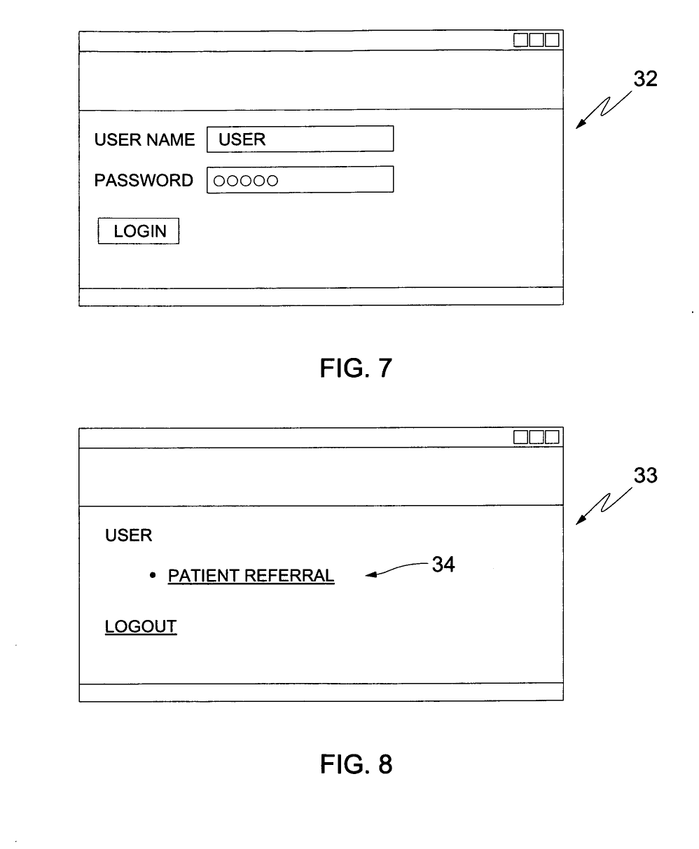

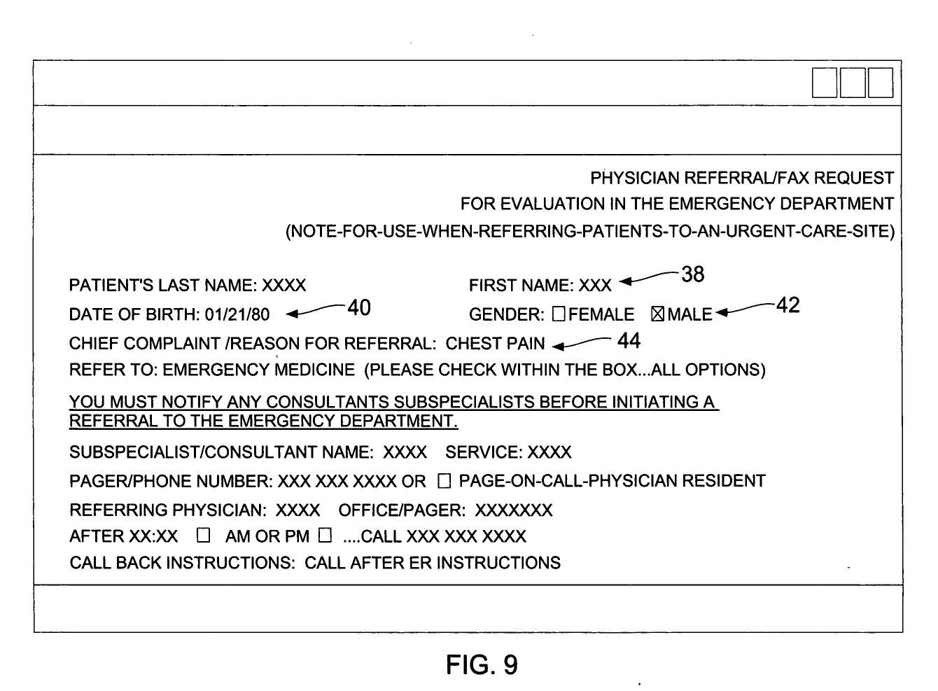

FIGS. 7-9 illustrate what happens when a lower level access user logs into the system. As shown in FIG. 7, a login screen 32 is shown where a user (low level of access) logs into the system. As shown in FIG. 8, after logging in, the user is taken to a screen 33 that presents the user with choices of documents to access. Again, in the present embodiment, only Patient Referral documents 34 are accessible. Once this hyperlink 34 is activated by the user, an MS Word document is created by the embodiment of the invention on-the-fly for the user as shown in FIG. 9. Again, this document is not stored in this form anywhere on the system. Instead, a template version of the Word document without any information filled into the fields is stored in one location as a CFQ; while fragmented, encrypted versions of the field data are stored in other locations. The document and its data are brought together only at the moment of request, in a version tailored to the permission level of the user. As can be seen in FIG. 9, the permission levels of the present user are low, since the patient name 38, Medical Record Number (not shown) and telephone number (not shown) are not filled into their corresponding fields on the form. Only the diagnosis 44, date of birth 40, gender 42 and other less sensitive information are provided.

A further embodiment of the present invention is another specific application in the healthcare industry. In scope, enhanced security and access to protected health information are applied at the individual patient, patient population, practitioner office, health care clinic, hospital, imaging center, laboratory, regional health information network, electronic medical record, electronic health record, corporate healthcare network, governmental (local, regional, national), and worldwide health information network levels.

At the individual patient level, embodiments of the present invention provide a mechanism by which protected health information can be stored on one or more devices in a secure but accessible fashion. As a concrete example, a patient could carry one or more thumb drives containing their protected health information, along with one or more additional devices such as a PDA or laptop computer. By appropriately authenticating in to the system, the patient would have access to these records as needed for their own personal health information management needs.

At the practitioner office level, embodiments of the present invention can be used to house protected health information on one or more servers in a secure but accessible data array. This allows one or more healthcare providers to gain access to required health records easily and across the network, as needed.

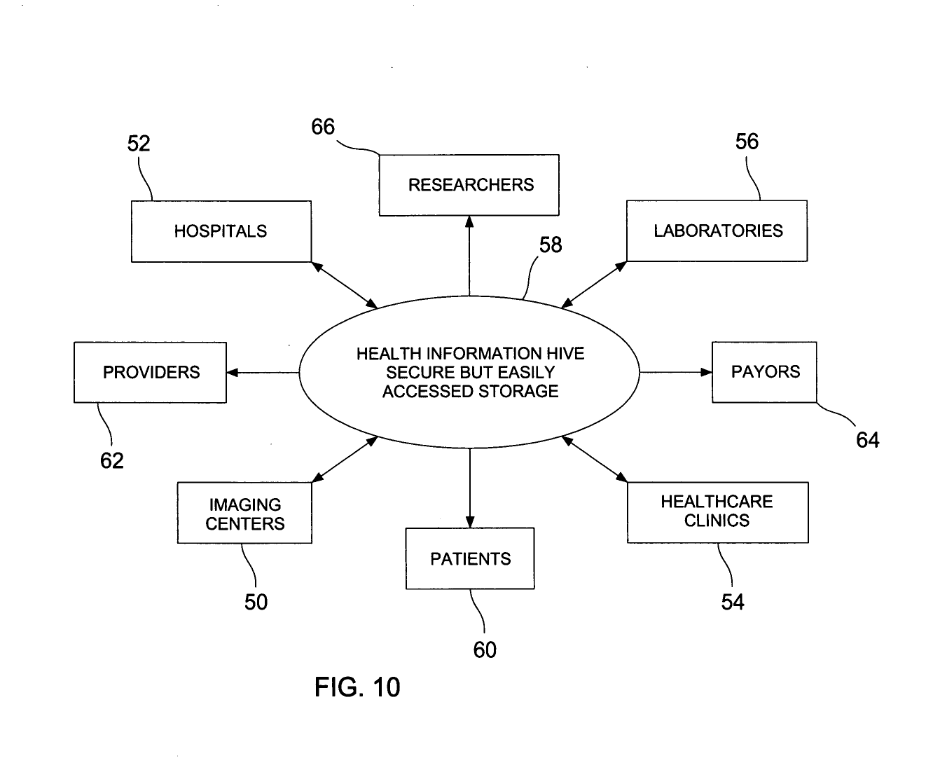

At the regional health information network level and in broader scale deployment, embodiments of the present invention become particularly powerful. Specifically, as illustrated in FIG. 10, standard format protected health information is directed outbound from imaging centers 50, hospitals 52, physician offices 54, freestanding laboratories 56, and other data repositories in HL7 or other standard format. As the information is transmitted across each firewall (“FW”), the present invention technology is used to encrypt, disaggregate, and scatter the information to an array of servers and other computer implemented and accessible information storage devices constituting a healthcare information “hive” 58.

This hive 58 can be accessed by patients 60, providers 62, payors 64, researchers 66, and others with appropriate access privileges. The ability of the present invention to present appropriate information while withholding protected information on a user by user basis, based on user privileging, increases access to healthcare information including test results and other health-care records, while protecting the confidentiality of patient information.

This healthcare information hive 58 increases access to information for providers 62 and payors 64 as well as patients 60, decreasing the likelihood that diagnostic tests that have already been performed satisfactorily and for which results are available will be inadvertently repeated by healthcare providers. This increased access to test results information offers a significant advantage over the current problem of lack of access by healthcare providers to patient records that are scattered across multiple healthcare information networks, making them difficult to retrieve in real-time. Poor access to existing test result data causes billions of dollars of waste each year in this country alone, by increasing the likelihood that healthcare practitioners will order redundant tests simply because they cannot get easy access to results of diagnostic tests already performed.

As an example, a diabetes clinic in a major metropolitan center may spend significant personnel resources trying to acquire test results for patients. Being unable to obtain all relevant test results, the clinic physician is forced to order repeat tests, wasting significant payor dollars, inconveniencing patients who must undergo unnecessary repeat tests, potentially exposing patients to additional risk such as radiation in the case of diagnostic imaging exams, and adding no value to the patient's healthcare overall.

By increasing healthcare provider access to test records, the present invention addresses this source of wasted funds, time, and potential increased exposure to the risk associated with undergoing unnecessary diagnostic tests. By making information more easily accessible to patients, providers, payors, and other stakeholders, the present invention eliminates waste caused by redundant diagnostic testing, thereby potentially saving the healthcare system many billions of dollars per year. It also improves patient safety by, for instance, making allergy information, past medical history, and medication records more easily available, so that healthcare providers can make better informed decisions in real-time. It also improves patient access to their own records, empowering patients to be better advocates of their own health care.

Additionally, the ability of the present invention to make a large and easily accessed data repository available for meta-analysis is of significant value. For example, having access to large populations of patients' health records, via the hive 58, can add tremendous power to current research efforts. Specifically, this access to researchers allows for the study of trends such as, for example: the emergence of new diseases; the increasing incidence of existing diseases; and the efficacy of particular treatments for classes of diseases across various populations with analysis specific to age, race, medical history criteria, genomic data or other demographic criteria. Such research will be of use in guiding new initiatives in predictive and personalized medicine. Access to very large data sets allows subtle changes across populations to be detected early and with a high degree of statistical certainty. This can have significant benefits in any area of research.

The present invention allows data to be stored in a decentralized manner, so that it is no longer necessary to store complete files on a single storage device such as a laptop computer. Thus a major benefit of the present invention is that it prevents the theft of a storage device from necessarily leaving the protected data stored on that device vulnerable to decoding and theft. This method of protecting confidentiality of patient data is of obvious value, and is badly needed. For instance, if a clinic's laptop computer containing patient records is lost or stolen and is protected only with traditional security measures, the encryption can be broken and the data misused. After implementation of the present invention, however, the loss of a single laptop, or thumb drive, or server, or even a group of such storage devices, does not result in the loss of complete sets of data, but rather meaningless fragments of data without sufficient context to allow the thief to decode, reconstruct, and misuse the data. The stolen laptop is, in and of itself, useless with regard to potential for theft of data.

The one risk in this scenario comes if a laptop and all of the external devices required to reconstitute complete documents are acquired by a single person or group. In that case, and given that off-the-shelf external drives permit open access to their file systems from the main system, the intruder would be able to find all the information required to reconstruct complete documents, and the security of the system would be broken. To address this, it might be possible to fabricate external drives that are, in essence, external Web servers. These external devices would not expose their file systems directly to the file system of the computer to which they are attached. Rather, they would, in essence, instantiate the distributed server system of the main distributed server structure in miniature. An intruder faced with such a system would have to crack each subsection of the external device in turn in order to access enough information to retrieve complete documents.

An additional benefit of this system, used in this way with laptops, is that the laptops would become nodes and the system would be able to know exactly which laptop contained which data. One of the problems in laptop loss is that the exact nature of the loss may be unknown; the precise contents of laptops are not stored centrally. The present invention could be enhanced with a logging function that would trace every download of fragment data to external devices. Thus, in case of loss, the exact data set lost would be known immediately. The local instantiation of the invention would itself track every data request, so that the reuse of the data could be logged (and these logs could be uploaded regularly to the central store). Finally, it should be possible to cripple most standards means of transmitting data between local machines, such as file copying or by viewing a document, saving it in some readable form, and then sending the document as an attachment. With these measures, the risk of data loss resulting from laptop or device loss could be cut dramatically.

Those of ordinary skill in the art will recognize that the application of this benefit is limitless. There are countless examples of stolen laptops leading to massive losses of protected information, causing billions of dollars of damages every year.

A further benefit of the present invention is its ability to provide redundant storage in the event of a catastrophic data center event such as fire, flood, tornado, etc. By providing scattered, redundant copies of critical data, and the ability to verify the completeness of records via means such as checksum comparisons as described above, the present invention provides secure data backup with on-the-fly data recovery capability. This benefit is of significant value in the healthcare industry.

It will be obvious to those of ordinary skill in the art that this feature of the present invention allows a “self-healing” feature to be built into server and other storage device arrays. Through technologies similar to those currently employed by redundant arrays of inexpensive disks (“RAID”s), which detect the failure of one or more disks and offer seamless data recovery without user-apparent loss of access to data during recovery, the present invention allows critical data to be protected in a network of servers such that the failure of any single or group of servers does not affect the integrity of the data, and the array automatically detects such failures and automatically recovers the failed servers as well as restoring the data to those servers by pushing data back to them in real time, in a manner invisible to the user and without interruption to service. This self-healing functionality follows an organic model, and could be used in limitless applications and environments.

Those of ordinary skill in the art will recognize that the application of this benefit allows, for instance, healthcare institutions to use low-cost servers to store critical data. Whereas the cost of storing medical information has traditionally required high cost servers due to the need for high availability and high reliability, the present invention allows data to be scattered across multiple server arrays—by coordinating and securing multiple copies of critical data, each copy of which is easily and quickly retrievable yet highly secure, the present invention places less pressure on any single storage device. This allows institutions to decrease hardware costs while increasing the security and redundancy/backup of critical data storage.

Following from the above description and invention summaries, it should be apparent to persons of ordinary skill in the art that, while the systems herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A computer-implemented method of distributing secure healthcare patient information, comprising the steps of:
providing a plurality of information servers, the information servers respectively storing one or more of a plurality of encrypted data fragments, the plurality of encrypted fragments comprising patient information fragments and one or more build information fragments that provide instructions for decrypting the patient information fragments and combining the decrypted patient information fragments into assembled healthcare patient information;
requesting, by a user, healthcare patient information;
authenticating the user to determine an authorization level of the user;
transmitting one or more build information fragments and one or more patient information fragments to a document assembler based, at least in part, on the authorization level of the user;
assembling, by the document assembler, the one or more patient information fragments based upon the instructions from the one or more build information fragments to produce assembled healthcare patient information; and
outputting the assembled healthcare patient information to an output device.

2. The method of claim 1, wherein the information servers also store a plurality of healthcare form templates; and
wherein the assembled healthcare patient information includes, at least in part, a combination of one or more patient information fragments and one or more healthcare form template.

3. The method of claim 1, wherein the output device is at least one of a display device, a computing device, a portable electronic device, a printing device, and a software application.

4. The method of claim 1, further comprising the step of:
prior to the transmitting step, replicating one or more of the encrypted data fragments and storing the one or more replicated encrypted data fragments in one or more of the plurality of information servers.

5. The method of claim 4, further comprising the step of:
prior to the assembling step, comparing at least one data fragment to at least one replicated encrypted data fragment to confirm the integrity of the at least one encrypted data fragment.

6. The method of claim 1, wherein the transmitting step further includes the step of recording, in a database, details of the transmission of the one or more build information fragments and the one or more patient information fragments to the document assembler.

7. The method of claim 1, wherein the requesting, authenticating, transmitting and assembling steps are implemented as web services on the Internet, and the web services are implemented in at least one of Hypertext Markup Language (HTML), Extensible Markup Language (XML), PHP, JavaScript and Asynchronous JavaScript and XML (AJAX).

8. The method of claim 1, wherein the plurality of information servers include one or more devices taken from a group consisting of: an electronic storage device, an internal hard drive, an external hard drive, an external flash drive, a network server device, an Internet server device, a web server, and a file server.

9. The method of claim 1, wherein the assembled healthcare patient information is not capable of being stored in an electronic format by the output device.

10. The method of claim 1, wherein at least one of the plurality of encrypted data fragments include a combination of patient information fragments and build information fragments.

11. A computer-implemented system for distributing secure healthcare patient information comprising:
a computing device adapted to output healthcare patient information upon request by a user;
an identity server adapted to confirm the user's identity and to determine an authorization level of the user;
a plurality of information servers, the information servers respectively storing one or more of a plurality of encrypted data fragments, the plurality of encrypted fragments comprising patient information fragments and one or more build information fragments that provide instructions for decrypting the patient information fragments and combining the decrypted patient information fragments into assembled healthcare patient information;
a file server adapted to collect one or more of the plurality of encrypted data fragments from the plurality of information servers, and decrypting the encrypted data fragments based, at least in part, on the instructions for decrypting the patient information fragments; and
a document server adapted to receive user requests for healthcare patient information, communicate with the identity server to determine the user's authorization level, communicate with the file server to retrieve the collected encrypted data fragments, and assemble healthcare patient information based, at least in part, on the instructions from the one or more build information fragments to produce assembled healthcare patient information;
whereby, upon request from the user, the document server transmits the assembled healthcare patient information to the computing device for output.

12. The system of claim 11, wherein the information servers also store a plurality of healthcare form templates; and
wherein the assembled healthcare patient information includes, at least in part, a combination of one or more patient information fragments and one or more healthcare form template.

13. The system of claim 11, wherein the computing device is at least one of a display device, a portable electronic device, a printing device, and a software application.

14. The system of claim 11, further comprising:
one or more redundancy servers adapted to replicate one or more of the encrypted data fragments and storing the one or more replicated encrypted data fragments in one or more of the plurality of information servers;
wherein at least one encrypted data fragment is compared to at least one replicated encrypted data fragment to confirm the integrity of the at least one encrypted data fragment.

15. The system of claim 11, further comprising an event database that records at least all user requests, user access attempts, healthcare patient information assembled and assembled healthcare patient information outputted.

16. The system of claim 11, wherein the plurality of information servers include one or more devices taken from a group consisting of: an electronic storage device, an internal hard drive, an external hard drive, an external flash drive, a network server device, an Internet server device, a web server, and a file server.

17. The system of claim 11, wherein the encrypted data fragments include at least one of a patient name, a patient identification number, a patient date of birth, a patient telephone number, a patient address, one or more patient conditions, one or more patient symptoms, a physician name, a physician referral, physician notes, one or more diagnosis, one or more suggested treatments, one or more prescribed treatments, one or more treatments previously attempted, one or more outcomes of previously attempted treatments, one or more suggested medications, one or more medications previously prescribed and one or more outcomes of previously prescribed medications.

18. The method of claim 11, wherein the plurality of encrypted fragments include a combination of patient information fragments and build information fragments.

19. A system for distributing secure healthcare patient information comprising:
a computer-implemented authentication component adapted to authenticate a user's request for healthcare patient information;
a computer-implemented data fragment component adapted to store a plurality of encrypted patient information fragments and transmit the encrypted patient information fragments in response to an authenticated user request;
a computer-implemented locks component adapted to allow or disallow access to the encrypted patient information fragments based, at least in part, on output from the authentication component;
a computer-implemented build information component adapted to store one or more build information fragments that provide instructions for decrypting the encrypted patient information fragments and combining the decrypted patient information fragments into a healthcare patient information document;
a computer-implemented composition component adapted to compose the healthcare patient information document based, at least in part, on the instructions from the build information component; and
an output component for receiving and outputting the healthcare patient information document.

20. A computer-implemented method of distributing secure healthcare patient information, comprising the steps of:
providing a plurality of information servers, the information servers respectively storing one or more of a plurality of encrypted data fragments, the plurality of encrypted fragments comprising patient information fragments and one or more build information fragments that provide instructions for decrypting the patient information fragments and combining the decrypted patient information fragments into assembled healthcare patient information;
replicating one or more of the encrypted data fragments and storing the one or more replicated encrypted data fragments in one or more of the plurality of information servers;
comparing at least one data fragment to at least one replicated encrypted data fragment to confirm the integrity of the at least one encrypted data fragment.
requesting, by a user, healthcare patient information;
authenticating the user to determine an authorization level of the user;
transmitting one or more build information fragments and one or more patient information fragments to a document assembler based, at least in part, on the authorization level of the user;
assembling, by the document assembler, the one or more patient information fragments based upon the instructions from the one or more build information fragments to produce assembled healthcare patient information; and
outputting the assembled healthcare patient information to an output device;
wherein the information servers also store a plurality of healthcare form templates; and
wherein the assembled healthcare patient information includes, at least in part, a combination of one or more patient information fragments and one or more healthcare form template.
